(19) United States
(12) Patent Application Publication
(10) Pub. No.: US 2022/0282774 A1
(43) Pub. Date: Sep. 8, 2022

(54) ADJUSTABLE ANGULAR ORIENTATION OF A FREELY RUNNING SHEAVE OF A BELT DRIVE

(71) Applicant: DEERE & COMPANY, MOLINE, IL (US)

(72) Inventor: GREGOR SCHOLL, Kirkel (DE)

(21) Appl. No.: 17/650,419

(22) Filed: Feb. 9, 2022

(30) Foreign Application Priority Data
Mar. 3, 2021 (DE) 102021105149.5

(51) Int. Cl. F16H 7/20; F16H 7/02

(52) U.S. Cl. CPC F16H 7/20; F16H 7/02; A01D 69/06

(57) ABSTRACT

A freely running sheave of a belt drive is supported on an angularly adjustable spindle for adjusting the angular orientation of the freely running sheave. The angular orientation of a spindle is changeable by a first wedge-shaped element and a second wedge-shaped element which each include a surface enclosing an acute angle relative to an orthogonal with respect to a longitudinal axis of the spindle. The wedge-shaped elements are flattened on opposite outer peripheral surfaces such that an open-end wrench can in each case be engaged therewith.

### RELATED APPLICATIONS

This application claims priority to DE 102021105149.5, which is hereby incorporated by reference in its entirety.

### FIELD OF THE DISCLOSURE

The present disclosure relates generally to the field of mechanisms for mounting sheaves to a structure or frame.

### BACKGROUND OF THE DISCLOSURE

Belt drives are used in agricultural harvesters in order to set drivable elements into rotation, in particular elements for crop processing or conveying, which require a relatively high amount of power, such as threshing drums or threshing rotors, chopping drums, accelerating blowers or grain processors. The belt drives have the advantage over drive connections with meshing gearwheels and shafts in that they provide a certain amount of elasticity such that load peaks caused by changes in crop flow are not conducted to an internal combustion engine or the output transmission thereof without damping. In addition, they can provide a type of overload protection.

A belt drive conventionally comprises a driving sheave, a driven sheave and a belt which is looped around both sheaves. In addition, in order to provide a belt tension, which is required for the force-fitting transmission of torque by the belt, use is made of freely running sheaves which are arranged movably about an axis of rotation counter to the force of a spring or an actuator, or are fixed. Sheaves of this type can also serve to allow the belt to run along a certain path. The belts can conventionally be provided with a V-shaped cross section or be composed of a plurality of elements which are arranged next to one another and each have a V-shaped cross section (referred to as power band). The sheaves can have corresponding depressions in which the belts penetrate in a form-fitting manner. There are also flat belts and associated flat sheaves and, in some applications, the flat rear side of the belt which is profiled on the other side revolves around a flat sheave in order to drive a shaft with an opposed direction of rotation to the driven sheave, for example in the case of grain processors of field choppers, see WO 2012/010396 A1.

It is often expedient, in order to achieve a sufficient service life of the belt, and in order to prevent the belt from running off, to arrange all the sheaves of the belt drive in a common plane. The holders of the freely running sheaves, like the shaft bearings assigned to the driven sheave and to the driving sheave, are conventionally connected rigidly to a frame of the harvester. This may lead to belts not running rectilinearly if, for example, the frame is not located precisely in its desired position at the attachment point of the holder of the freely running sheave because of tolerances or deformation caused by welding work. While tolerances in the axial direction of the sheave can be compensated for relatively simply by washers or the like, it is more problematic to compensate for inclinations of the axis of rotation of the sheave (toe angle and camber angle). A concern in the event of greater inclinations is a higher degree of wear of the belt (for example if the flanks of the V-shaped belt run only along one flank of the depression of the sheave) and/or the belt running off from one of the sheaves. Both problems mentioned arise not only at the freely running sheave, but also at the driving and/or driven sheave.

An adjustable holder of a freely running belt pulley is described in the prior art (U.S. Pat. No. 7,585,238B2). A spindle serving for the rotatable support of the pulley is arranged at one end in a convex spherical seat arrangement such that the spindle is mounted pivotably adjacent to a first side of the pulley while the spindle is supported adjustably on the other side of the pulley in two mutually orthogonal directions by means of screws. Although the holder according to U.S. Pat. No. 7,585,238B2 permits an adjustment of the toe angle and camber angle and therefore correct orientation of the pulley, the spherical support of the pulley on its one side and the mutually independent adjustment of the two angles by two screws on the other side of the pulley provides a relatively complicated holder which extends between the two sides of the pulley, and the two angles have to be adjusted separately from each other, which may require a large amount of time, particularly if the adjustment directions of the screws are not oriented precisely in order to adjust the camber angle with one screw and the toe angle with the other screw.

A further arrangement for adjusting the inclination of a freely running sheave is shown in WO 2021/009577A1. The freely running sheave is mounted there on a sleeve which, for its part, is fastened to a fixed wall by means of a screw bolt. Between the wall and the sleeve there are two washers which are each equipped with a gripping piece and are each wedge-shaped, i.e. one surface thereof encloses an acute angle with the radius of the screw bolt. By means of relative rotation of the washers with respect to each other, the inclination of the screw bolt in relation to the plane of the wall is adjusted, and the azimuthal orientation of the screw bolt is adjusted by joint rotation of the washers. The arrangement according to WO 2021/009577A1 requires that an adjustment of the washers is possible only if a nut of the screw bolt is very loosely tightened, and therefore the adjustment can take place only very imprecisely.

### SUMMARY OF THE DISCLOSURE

According to an aspect of the present disclosure, a belt drive can be provided having a driving sheave, a driven sheave, a freely running sheave and a belt which is in contact with the sheaves. The freely running sheave is supported on an angularly adjustable spindle for adjusting the angular orientation of the freely running sheave in two different directions. The angular orientation of the spindle is changeable by a first wedge-shaped element and a second wedge-shaped element which each include an inclined surface enclosing an acute angle relataive to an orthogonal with respect to a longitudinal axis of the spindle such that the angle of inclination of the spindle is adjustable by relative rotation of the first wedge-shaped element and the second wedge-shaped element in relation to each other about the spindle, while the azimuthal orientation of the spindle is adjustable by joint rotation of the first wedge-shaped element and the second wedge-shaped element about the spindle. The first and second wedge-shaped elements are flattened on their opposite outer peripheral surfaces such that an open-end wrench can in each case be engaged therewith.

It is entirely conceivable for yet more sheaves to be present in said belt drive, either in the form of additional outputs and/or further smooth pulleys which are used as a belt guide, and which can be adjustable in the manner according to the disclosure.

It is proposed, in other words, to adjust the inclination of the spindle (in relation to the plane of the belt) and the azimuthal orientation of the spindle (about its own axis) by means of two wedge-shaped elements. The wedge-shaped elements each comprise a surface which is inclined in relation to the longitudinal axis. It is thereby possible to rotate the wedge-shaped elements relative to each other about the longitudinal axis of the spindle in order to adjust the absolute inclination of the spindle in relation to the plane of the belt, and to jointly rotate the wedge-shaped elements in order to adjust the azimuthal orientation of the spindle. A more complicated holder extending between both sides of the pulley is thereby not required, and, also, the two angles (camber and toe) can be jointly adjusted, which simplifies and accelerates the adjustment operation. The adjustment can be brought about by means of two open-end wrenches which are pushed over flattened outer perhipheral surfaces of the wedge-shaped elements. The open-end wrenches thereby firstly permit a relatively sensitive adjustment, and enable the adjustment to take place with a spindle which is already considerably tightened and which will be adjusted less after the final fixing, which permits a more precise adjustment of the orientation of the freely running sheave.

The spindle can be supported by a spherical mounting on a frame, on which frame the driving sheave and the driven sheave can also be rotatably supported. The spherical mounting can comprise a convex disk which interacts with a concave region, although it would also be conceivable to configure the disk concavely and the region convexly. The disk can be connected to the spindle, while the concave region can be connected to the frame.

The freely running sheave can be supported on a bushing surrounding the spindle, either via an arm mounted pivotably on the bushing, or directly.

The wedge-shaped elements can be arranged on the spindle between the spherical mounting of the spindle and the bushing. In particular, the inclined surfaces of the wedge-shaped elements can lie on each other, and the bushing can be coupled to the second wedge-shaped element. The first wedge-shaped element can lie on a ring connected to the frame, while the bushing can be fixed on the spindle by a fastening mechanism lying thereon on that side of the bushing which is spaced apart from the second wedge-shaped element (for example a nut screwed onto a thread of the spindle and optionally washers for securing the axial position of the bushing and therefore of the freely running sheave).

The proposed belt drive may be used on harvesters in order to connect any crop processing and/or conveying element, or another element to be driven, directly or indirectly to a drive source, for example to an internal combustion engine.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 shows a schematic lateral view of a self-propelled field chopper with a belt drive;

FIG. 2 shows a perspective view of a holder with a sheave attached thereto;

FIG. 3 shows an exploded view of the holder from FIG. 2 from one side,

FIG. 4 shows an exploded view of the holder from FIG. 2 from the other side;

FIG. 5 shows a section through the holder from FIG. 2 along the line 5-5 in FIG. 2 in an orthogonal orientation; and

FIG. 6 shows a section through the holder from FIG. 2 along the line 5-5 in FIG. 2 in an angular orientation.

### DETAILED DESCRIPTION OF THE DRAWINGS

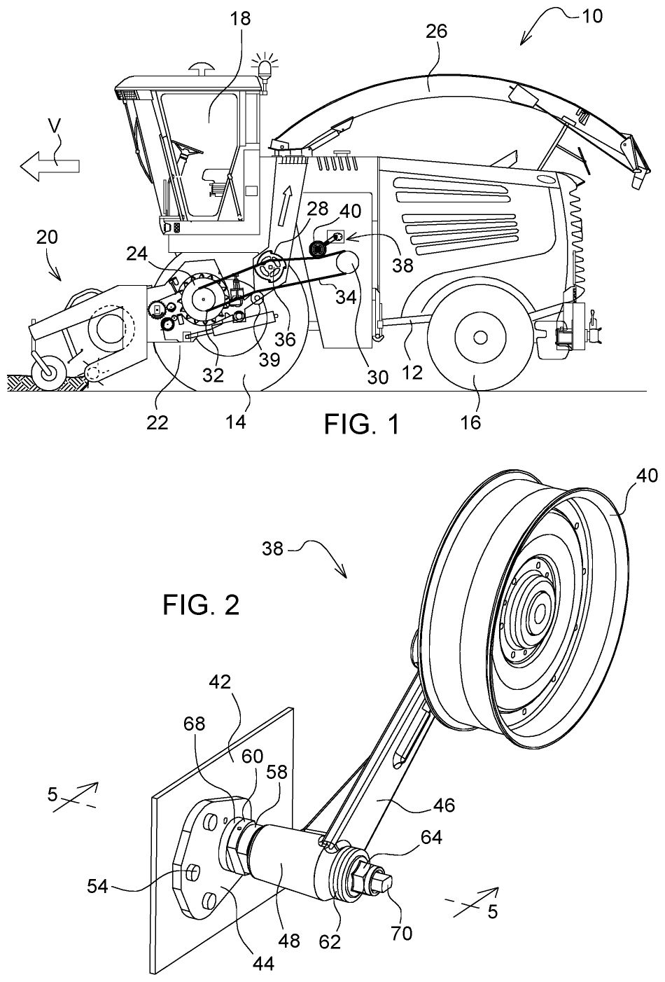

Referring to FIG. 1, there is shown a self-propelled field chopper 10 in a schematic side view. The field chopper 10 is constructed on a frame 12 which is supported by front driven wheels 14 and steerable rear wheels 16. The field chopper 10 is controlled from a driver's cab 18, from which a harvesting header 20 in the form of a pickup is visible. Crop, for example grass or the like, picked up from the ground by means of the harvesting header 20 is supplied via an inlet conveyor 22 having pre-compression rollers, which are arranged inside an inlet housing on the front side of the field chopper 10. The crop is then directed to a chopping drum 24 which is arranged below the driver's cab 18 and which chops the crop into small pieces and feeds same to a conveying apparatus 28. The crop leaves the field chopper 10 to a transport vehicle driving alongside via a discharge chute 26 which is rotatable about an approximately vertical axis and is adjustable in inclination. Directional details, such as laterally, bottom and top, refer herein to the forward direction of movement V of the field chopper 10 that runs to the left in FIG. 1.

The chopping drum 24 and the conveyor apparatus 28 are driven by a belt drive which comprises a driving sheave 30, which is driven via a transmission or directly by an internal combustion engine, not shown, a first driven sheave 32, which is in torque-locking connection with the chopping drum 24, a second driven sheave 36, which is in torque-locking connection with the conveying apparatus 28, a belt 34 and a freely running sheave 40 which is fastened by means of a holder arrangement 38 to the frame 12. The rotary bearings of the chopping drum 24, of the conveying apparatus 28 and of the driving sheave 30 are also supported by the frame 12. The freely running sheave 40 interacts with the return strand of the belt 34 which, during the normal harvesting mode, moves upward. A further sheave 39 laterally guides the driving, lower strand of the belt 34. Said further sheave 39 can be attached adjustably in the manner described below with respect to the sheave 40.

The belt drive described here is only one example of a belt drive in an agricultural harvester, which could also be designed, for example, as a combine harvester, and the belt drive can produce a drive connection between any driving element and any crop conveying and/or processing elements or any other elements to be driven, for example a cooling fan or a pump unit.

The freely running sheave 40 serves to act upon the belt 34 with the tension required for transmitting torque. The holder arrangement 38 can hold the freely running sheave 40 rigidly or rotatably on the frame 12; in the second case, the freely running sheave 40 would be pretensioned by a spring or an actuator (for example hydraulic cylinder) in order to keep the belt 34 taut.

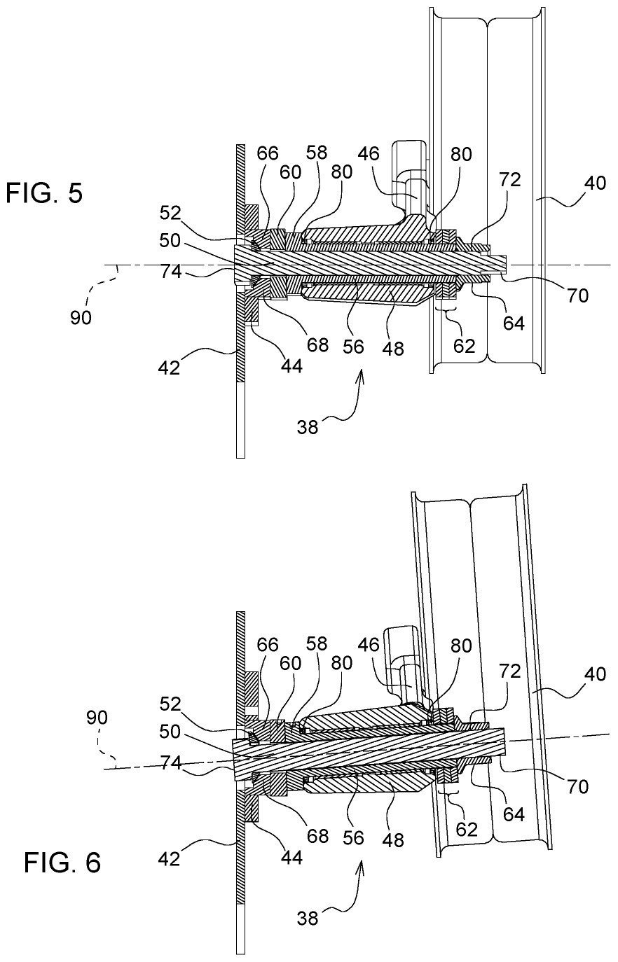

The holder arrangement 38 is illustrated in detail in FIGS. 2-6. It comprises an arm 46 which, at its distal end, supports the freely running sheave 40. The freely running sheave 40 is therefore mounted in a freely rotatable manner at the distal end of the arm 46. The arm 46 can be connected at its proximal end rigidly to a sleeve 48 or can be produced integrally therewith. The sleeve 48 which comprises a central opening which extends parallel to the axis of rotation of the sheave 40 is mounted by means of mountings 80 (see FIG. 5) on a bushing 56 arranged within the sleeve 48. A torque-locking connection between the frame 12 and the arm 46 is not illustrated in FIGS. 2-6; however, it can take place at any location, for example by means of a spring or an actuator or a rigid connection, which in each case act at one end on the arm 46 and at the other end on the frame 12. In another embodiment, the sheave 40 and in particular the further sheave 39 could be connected directly to the holder arrangement 38 (i.e. could be rotatably supported directly or indirectly on the bushing 56) instead of via the arm 46 and the sleeve 48.

Furthermore, a flange 44 can be fastened to a wall 42 which is part of the frame 12 or is connected thereto in any desired manner, for which purpose use can be made of fastening screws 54 which extend through bores in the wall and with their threads into threads introduced into the flange 44. Instead of fixing the flange 44 by threads introduced therein, other attachment mechanisms or structure such as separate nuts could also be used.

A spindle 50 which comprises a hexagon head 74 at one end and a thread 72 with an outer flattened portion 70 at the other end extends through an opening in the wall 42 and through an opening in the flange 44, and also through an opening in a protruding ring 68 which is connected to the flange 44 or is integral therewith and is provided on that side of the flange 44 which is spaced apart from the wall 42. In the assembled state, a spherically convex disk 52 lies with its flat side on the head 74 of the spindle 50 and with its spherically convex surface on a spherically concave region 66 of the flange 44.

In the assembled state, the spindle 50 furthermore extends through an opening in a first wedge-shaped element 60, which comprises an inclined surface 76, and through the bushing 56, to the end of which adjacent to the first wedge-shaped element 60 a second wedge-shaped element 58 is fastened or is connected integrally thereto or is formed separately therefrom and which likewise comprises an inclined surface 78 which lies on the inclined surface 76 of the first element 60. In the assembled state, the bushing 56 is arranged inside the sleeve 48. The bushing 56 is outwardly adjoined by a number of washers 62 on which from the outside a nut 64 lies, the nut 64 serving as a fastening mechanism for the spindle 50 and being screwed onto the thread 72 of the spindle 50. The washers 62 can be distributed both on the left side of the sleeve 48 and on the right side in order to vary the axial position of the arm 46 and thus of the sheave 40.

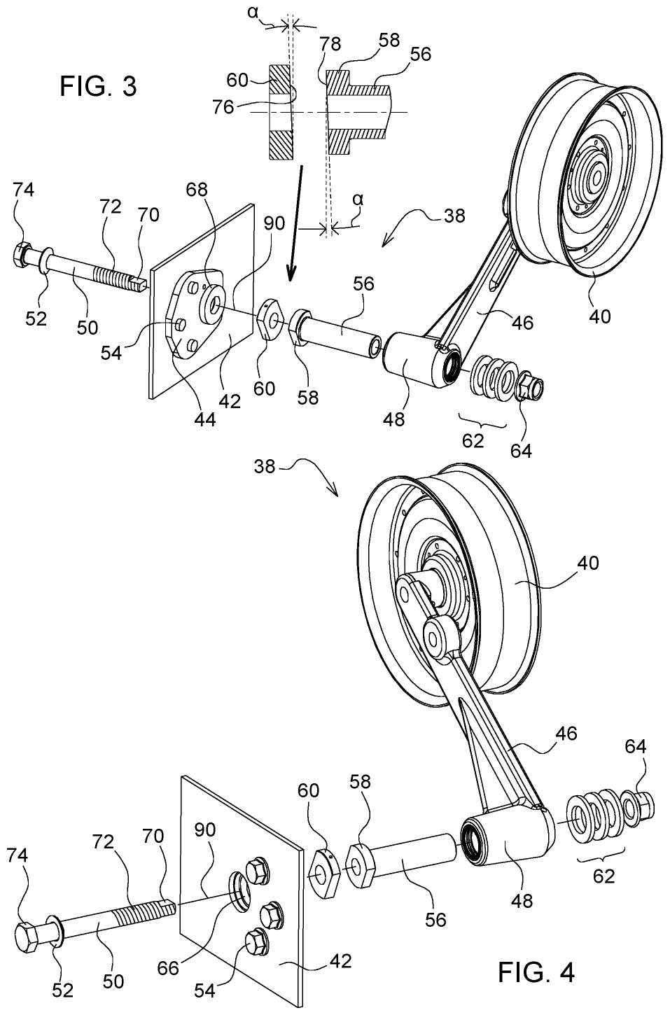

As shown in the enlarged detail of FIG. 3, the surfaces 76, 78 of the wedge-shaped elements 60, 58 lying on each other are not arranged precisely orthogonally with respect to the longitudinal axis 90 of the spindle 50, but rather at an acute angle α, which is shown greatly exaggerated there and can be a few angular degrees, with respect to the radial of the spindle 50.

The wedge-shaped elements 60, 58 are flattened on opposite peripheral outer surfaces such that an open-end wrench can in each case be attached or engaged therewith in order to adjust their position. By rotation of the wedge-shaped elements 58, 60 in relation to each other about the longitudinal axis 90 of the spindle 50, the angle of inclination of the spindle 50, and thus of the bushing 56, the sleeve 48, the arm 46 and the sheave 40, can thus be adjusted in relation to the plane of the wall 42 and the frame 12. The convex disk 52 rotates here in relation to the concave element 66.

Joint rotation of the two wedge-shaped elements 58, 60 about the longitudinal axis 90 of the spindle 50 leads, by contrast, to an azimuthal rotation of the bushing 56, the sleeve 48, the arm 46 and the sheave 40 about the longitudinal axis 90 of the spindle 50. When the nut 64 is not too firmly tightened, and with the flattened portion 70 being used for attaching a second wrench when the nut 64 is tightened with a first wrench, these rotations serve to align the axis of rotation of the sheave 40 with the axes of rotation of the other sheaves 30, 32, 36 of the belt drive (i.e. in the plane of the belt 34). Finally, the nut 64 is tightened, using the flattened portion 70 for counter holding, in order to fix the position.

The sheave 40 can be shifted in the longitudinal direction of the spindle 50 by moving the washers 62 onto the other side of the sleeve 48.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A belt drive comprising:
a driving sheave;
a driven sheave;
a freely running sheave;
a belt in contact with the driving sheave, the driven sheave, and the freely running sheave;
the freely running sheave being supported on an angularly adjustable spindle for adjusting the angular orientation of the freely running sheave in two different directions; and
the angular orientation of the spindle being changeable by a first wedge-shaped element and a second wedge-shaped element which each include a respective inclined surface enclosing an acute angle relative to an orthogonal with respect to a longitudinal axis of the spindle, wherein an angle of inclination of the spindle is adjustable by relative rotation of the first wedge-shaped element and the second wedge-shaped element in relation to each other about the spindle, wherein an azimuthal orientation of the spindle is adjustable by joint rotation of the first wedge-shaped element and the second wedge-shaped element about the spindle, and wherein the first and second wedge-shaped elements are flattened on respective opposite outer perhipheral surfaces such that an open-end wrench can in each case be engaged therewith.

2. The belt drive of claim 1, wherein the spindle is supported by a spherical mounting on a frame, and the driving sheave and the driven sheave are rotatably and operatively supported by the frame.

3. The belt drive of claim 2, wherein the spherical mounting comprises a convex disk which interacts with a concave region.

4. The belt drive of claim 3, wherein the convex disk is coupled to the spindle, and the concave region is connected to the frame.

5. The belt drive of claim 3, wherein the freely running sheave is supported on a bushing surrounding the spindle.

6. The belt drive of claim 5, wherein the first and second wedge-shaped elements are arranged on the spindle between the spherical mounting of the spindle and the bushing.

7. The belt drive of claim 6, wherein the respective inclined surfaces of the first and second wedge-shaped elements lie on each other.

8. The belt drive of claim 7, wherein the bushing is coupled to the second wedge-shaped element.

9. The belt drive of claim 8, wherein the first wedge-shaped element lies on a ring connected to the frame, and the bushing is fixed on the spindle by a fastening mechanism lying on the bushing on that side of the bushing which is spaced apart from the second wedge-shaped element.

10. The belt drive of claim 9, wherein the belt drive is operatively connected to an agricultural harvester.

11. The belt drive of claim 1, wherein the spindle includes an end having a flattend portion configured for engaging a wrench.

12. A belt drive comprising:
a spindle;
a freely running sheave supported on the spindle;
a first wedge-shaped element and a second wedge-shaped element supported on the spindle, wherein the first wedge-shaped element and the second wedge-shaped element are rotatable about a longitudinal axis of the spindle relative to each other and relative to the spindle to adjust an orientation of the freely running sheave relative to the spinde;
wherein each of the first wedge-shaped element and the second wedge shaped element include a respective inclined surface positioned against each other and forming an acute angle relative to an orthognonal with respect to the longitudinal axis of the spindle; and
wherein each respective one of the first wedge-shaped element and the second wedge-shaped element are flattened on opposing outer peripheral surfaces for engaging an open end of a wrench.

13. The belt drive of claim 12, wherein the spindle includes an end having a flattend portion configured for engaging a wrench.
